(19) United States
(12) Patent Application Publication
(10) Pub. No.: US 2020/0387873 A1
(43) Pub. Date: Dec. 10, 2020

(54) CALENDAR OPTIMIZATION

(71) Applicant: Microsoft Technology Licensing, LLC, Redmond, WA (US)

(72) Inventor: Rajath Kumar RAVI, Hyderabad (IN)

(21) Appl. No.: 16/436,789

(22) Filed: Jun. 10, 2019

(51) Int. Cl. G06Q 10/10

(52) U.S. Cl. CPC G06Q 10/1095

(57) ABSTRACT

Techniques for optimizing electronic calendars are disclosed. One or more alternative meeting times for a new meeting or an existing (e.g., previously scheduled) meeting are determined and suggested to at least one attendee. The one or more alternative meetings are proposed at times that reduce the amount of time between meetings and increase the amount of focus time of at least one attendee to the meeting. Focus time is a given time period where a user can focus on a task, such as a work assignment, without any scheduled interruptions (e.g., without any scheduled meetings).

### BACKGROUND

Calendar applications provide users with an electronic version of a calendar and typically enable users to schedule meetings with other users (“attendees”). In some instances, a calendar application includes a scheduling assistant that assists a meeting organizer in scheduling a meeting. Meeting assistants can be used to find times when all attendees are available for a meeting. However, for some users, their scheduled meetings are scattered throughout a day and leave little time between meetings for the user to focus on other work tasks.

It is with respect to these and other general considerations that embodiments have been described. Also, although relatively specific problems have been discussed, it should be understood that the embodiments should not be limited to solving the specific problems identified in the background.

### SUMMARY

Embodiments disclosed herein provide techniques to propose one or more alternative meeting times to increase the focus time of some or all of the attendees. As used herein, focus time is a given time period where a user can focus on a task, such as a work assignment, without any scheduled interruptions (e.g., without any scheduled meetings). For example, embodiments may be used to improve the focus time of the employees at a business or organization, where the electronic calendars (or the computer-generated calendar data) are accessible through one or more networks.

In one aspect, a method includes analyzing computer-generated calendar data associated with the electronic calendar of each attendee to a meeting in response to receiving a request to schedule the meeting. The request for the meeting can include a date for the meeting, a start time and an end time for the meeting, and the meeting attendees. For each attendee, one or more open time periods within a meeting boundary associated with any existing meetings on the date is determined. The meeting boundary is a period of time immediately before or immediately after the existing meeting on the same date and an existing meeting is scheduled on the electronic calendar of at least one attendee. For each open time period, an amount of focus time for each attendee is determined. A score for each open time period may be computed based on the amounts of focus times determined for that open time period. Based on each score, one or more alternative meeting times for the meeting is selected and a notification is transmitted over the network to a computing device associated with at least one attendee. The notification includes the one or more alternative meeting times and a user interface selection control for each alternative meeting time.

In another aspect, a system includes a processing device and a memory operably connected to the processing device. The memory stores instructions, that when executed by the processing device, cause operations to be performed, including receiving, over a network, a request to schedule a meeting on electronic calendars associated with a plurality of attendees. The request includes a date for the meeting, a meeting start time, a meeting end time, and the plurality of attendees. In response to receiving the request, computer-generated calendar data associated with the electronic calendars of each attendee is analyzed. For each attendee, one or more open time periods within a meeting boundary associated with any existing meetings on the date is determined. The meeting boundary is a period of time immediately before or immediately after an existing meeting and at least one attendee has an existing meeting on the date. For each open time period, an amount of focus time for each attendee is determined and a score is computed for each open time period. The score is based on the amounts of focus times determined for that open time period. Based on each score, one or more alternative meeting times for the meeting is selected and a notification panel that includes the one or more alternative meeting times and a user interface selection control for each alternative meeting time is transmitted over the network to a computing device associated with at least one attendee.

In yet another aspect, a method includes analyzing computer-generated calendar data associated with a plurality of electronic calendars, and for a first existing meeting scheduled on the plurality of electronic calendars, determining one or more open time periods within a meeting boundary associated with a second existing meeting that is scheduled on the same day as the first meeting on one of the plurality of electronic calendars. The meeting boundary is a period of time immediately before or immediately after the second existing meeting. For each open time period, the processing device determines an amount of focus time for each attendee of the first existing meeting and computes a score for each open time period. The score is based on the amounts of focus times determined for that open time period. Based on each score, the processing device selects one or more alternative meeting times for the first existing meeting. A notification is transmitted over the network to a computing device associated with at least one attendee of the first existing meeting, where the notification includes the one or more alternative meeting times, a user interface selection control for each alternative meeting time, a meeting time of the first existing meeting, and a user interface selection for the meeting time of the first existing meeting. A determination is made as to whether a selection is received within a given period of time in response to the notification. When the selection is received within the given time period, and the selection is one of the one or more alternative meeting times, a notification is caused to be transmitted to each attendee of the first existing meeting regarding the alternative meeting time. When the selection is received within the given time period, and the selection is the meeting time of the first existing meeting, the first existing meeting is maintained on the plurality of electronic calendars at the meeting time of the first existing meeting.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures. The elements of the drawings are not necessarily to scale relative to each other. Identical reference numerals have been used, where possible, to designate identical features that are common to the figures.

FIG. 1 depicts a block diagram of a distributed computing system in which aspects of the present disclosure may be practiced;

FIG. 2 is a flowchart of a method of optimizing electronic calendars;

FIG. 3 illustrates an example preferences user interface for setting one or more meeting boundaries and an amount of focus time;

FIG. 4A depicts an example day in an electronic calendar prior to optimizing the electronic calendar;

FIG. 4B illustrates an example day in the electronic calendar shown in FIG. 4A after the calendar is optimized;

FIG. 5 is a flowchart of an example method of optimizing electronic calendars for a new meeting;

FIG. 6 depicts an example graphical user interface for proposing one or more alternative meeting times;

FIG. 7 is a flowchart of an example method of optimizing existing meetings previously scheduled in electronic calendars;

FIG. 8 is a flowchart of a method of monitoring and providing reports regarding calendar optimization;

FIG. 9 is a block diagram depicting example physical components of a computing device with which aspects of the disclosure may be practiced;

FIGS. 10A-10B are simplified block diagrams illustrating a mobile computing device with which aspects of the present disclosure may be practiced; and

FIG. 11 is a block diagram depicting a distributed computing system in which aspects of the present disclosure may be practiced.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

Calendaring software is widely used throughout businesses, organizations, venture, and other entities (hereinafter “enterprise”). Often, the users are situated at different locations, such as in different buildings or in different cities. Among other functions, the calendaring software enables the user to schedule meetings with other users (at any location) via one or more networks. The meetings can be held in a conference room, via a conference call, and/or via video conference. The data associated with the electronic calendars is stored as computer-generated and computer-readable data at each user's computing device or at a central storage device or memory that is accessible over a network. In some situations, a user can be restricted from viewing the calendars of another user because the other user has not given the user permission to view his or her calendar, or the calendar may be password protected. Thus, it can be challenging for the user to schedule the meetings at times that improve or maximize the amount of time the other users can spend on other work or tasks.

Meetings can interrupt a user's work flow and in some instances, be a disturbance to the user. Embodiments described herein propose one or more alternative meeting times for a requested meeting based on focus time. Focus time is a given time period where a user can focus on a task, such as a work assignment, without any scheduled interruptions (e.g., without scheduled meetings). Focus time can be computed as minutes and/or hours. In a non-limiting embodiment, focus time may be a continuous block of two hours or more without any scheduled meetings. A smaller number of larger blocks of focus time can increase the total amount of focus time for the employees, and thus increase their productivity, compared to the total focus time of employees that have a larger number of smaller blocks of focus time.

Increasing a user's focus time at an enterprise can improve the productivity and/or effectiveness of the user. Additionally, in some instances, the revenue generated by the enterprise can increase when the total amount of focus time across the enterprise increases.

The disclosed embodiments can suggest one or more alternative meeting times for a new meeting (one-time or recurring) that is scheduled in the future, as well as for existing (e.g., scheduled) one-time or recurring meetings. For example, an alternative meeting time may be suggested to the meeting organizer. The one or more alternative meetings are proposed at times that reduce or minimize the amount of time between two meetings. Meetings are scheduled as close together as possible to increase the amount of focus time of at least one attendee to a meeting. The techniques discussed herein can be performed once, periodically, or at select times for select meetings or for all meetings. In one aspect, the total focus time for an enterprise may reach a convergence over time where the total focus time is near or substantially at an optimum value.

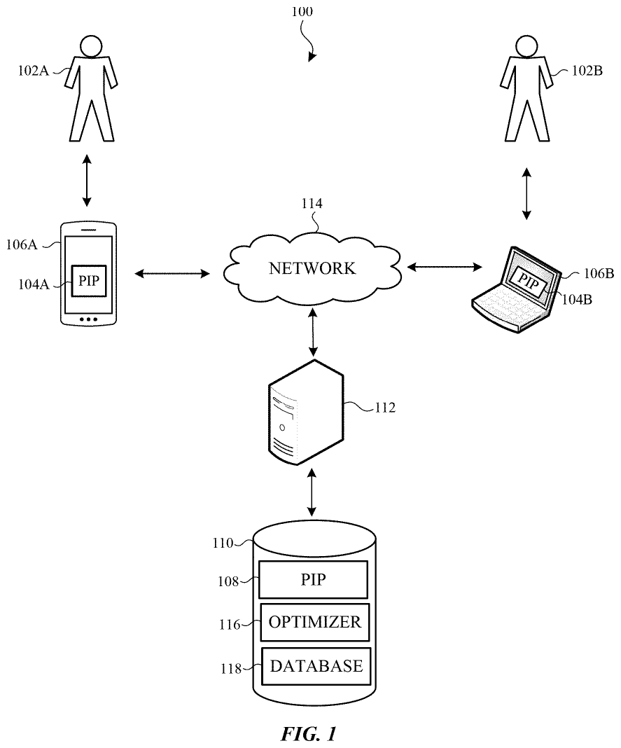

Non-limiting and non-exhaustive examples are described with reference to the following FIGS. 1-11. The elements of the drawings are not necessarily to scale relative to each other. Identical reference numerals have been used, where possible, to designate identical features that are common to the figures.

FIG. 1 illustrates a block diagram of a distributed computing system in which aspects of the present disclosure may be practiced. In one embodiment, the system 100 is an enterprise system that provides users 102A, 102B with a personal information program (PIP) 104A, 104B, respectively, that the users 102A, 102B can access and interact with on computing devices 106A, 106B. Each PIP 104A, 104B includes an electronic calendar program that provides a calendar showing the days of the week and operations that enable the users 102A, 102B to schedule meetings, events, and other activities. In some instances, the PIP 104A, 104B may also include a contact list, an address book, tasks, and/or other features.

The calendar data in the PIPs 104A, 104B can be stored in a PIP 108 that is stored on one or more storage device (represented by storage device 110). The PIP 108 executes on one or more server computing devices (represented by server computing device 112). The PIPs 104A, 104B executing on computing devices 106A, 106B can access and/or interact with the PIP 108 executing on the server computing device 112 using one or more networks (represented by network 114). The network 114 is illustrative of an intranet and/or a distributed computing network such as the Internet.

As will be described in more detail later, an optimizer program 116 stored on storage device 110 and executed by the server computing device 112 can analyze the electronic calendars (or the computer-generated calendar data) of a group of users, determine one or more alternative meeting times for the attendees of a meeting based on focus time, and provide the one or more alternative meeting times to at least one computing device associated with an attendee of the meeting (e.g., the meeting organizer). The alternative meeting time(s) may be proposed to the attendee in a graphical user interface that is configured to enable the attendee to accept an alternative meeting time or reject the alternative meeting times. In some aspects, the optimizer program 116 may store data relating to the scheduling of meetings and/or to the changes in user focus times in a database 118 or other memory structure.

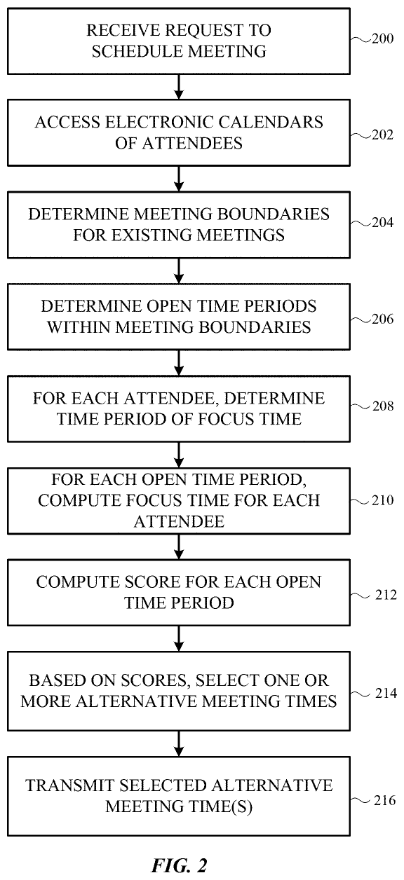

FIG. 2 is a flowchart of an example method of optimizing electronic calendars in accordance with some embodiments. Initially, as shown in block 200, a request to schedule a meeting is received. The request to schedule the meeting can include a variety of parameters, including a date, a list of users (hereinafter “attendees”), and a time (e.g., start and end times). The request may also include additional parameters, such as a subject, a location (e.g., a conference room), and one or more attachments (e.g., documents).

Based on the list of attendees and the meeting date in the request, the electronic calendars (or the computer-generated calendar data) of the attendees are accessed at block 202. The meeting boundaries of any existing meetings (previously scheduled meetings) on the requested date is determined for each attendee (block 204). As used herein, a meeting boundary is a period of time immediately before and/or after an existing meeting. Any suitable period of time can be used as a meeting boundary. For example, a meeting boundary can be one hour or two hours immediately before and/or after an existing meeting. The amount of time associated with each meeting boundary can be pre-determined, may be received from an attendee (e.g., a meeting organizer), or can be set by each user (e.g., set as a preference setting in his or her electronic calendar). Additionally or alternatively, or alternatively, the meeting boundary before an existing meeting (e.g., the period of time before the meeting) can be the same as, or differ from, the meeting boundary after the existing meeting.

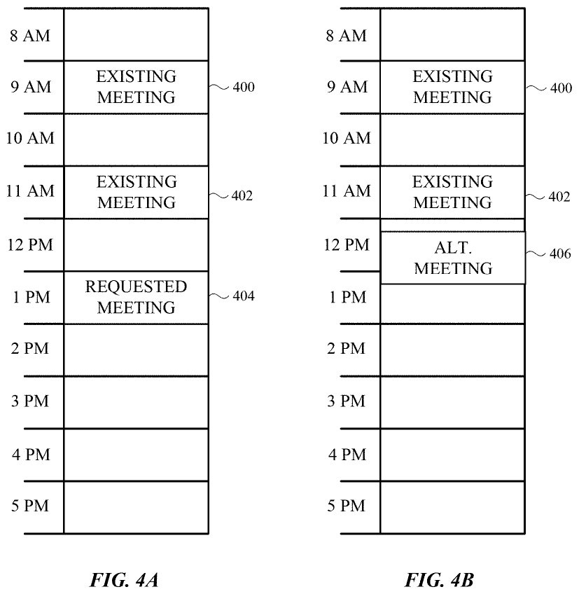

Based on the meeting time and the meeting duration (e.g., start and stop times) in the request, and on the meeting boundary or boundaries, one or more alternative meeting times on the date is determined at block 206. In one aspect, each attendee's calendar is reviewed to determine if the attendee has any free or open time periods within the meeting boundary/boundaries. For example, an optimizer program (e.g., optimizer program 116 in FIG. 1) can access the date in each attendee's electronic calendar and determine if that attendee has any open time periods in the meeting boundaries of any existing meetings on that day. An example process of determining open time periods in the meeting boundaries of an existing meeting is described in more detail in conjunction with FIGS. 4A and 4B.

Next, as shown in block 208, a period of time that constitutes a focus time is determined for each attendee. As described earlier, focus time is a given time period where an attendee can focus on a task, such as a work assignment, without any scheduled interruptions (e.g., without scheduled meetings). For example, focus time can be a continuous block of time that is greater than two hours without any scheduled meetings.

In one embodiment, the focus time period is determined by a person within an enterprise and is the same for every employee. However, since users work differently and can have personalized or individual focus time period requirements, in other aspects a user can set his or her focus time (e.g., any time period from thirty minutes to N hours, where N is a number greater than thirty minutes). For example, a user can set a focus time period as a setting in a preferences menu of an electronic calendar program.

An amount of focus time is computed for each attendee based on an assumption that the meeting is scheduled at each open time period (block 210). Based on the focus time period determined at block 208, an attendee's electronic calendar is analyzed to determine how much focus time the attendee has on that day assuming the meeting is scheduled at the open time period. For example, if the focus time associated with an attendee is two hours, and if the meeting is scheduled at a particular alternative meeting time, the open blocks of time that are 2 hours or more are summed to determine the amount of focus time the attendee has on that day.

An example process of determining focus time is described in more detail in conjunction with FIGS. 4A and 4B.

A score for each alternative time period is computed at block 212. In one embodiment, the focus times for all attendees at each alternative meeting time are summed to provide the score for that alternative meeting time. For example, when a meeting has two attendees and two alternative meeting times, the total focus time for the first attendee may be +3 hours if the meeting is scheduled at the first alternative meeting time, and the total focus time for the second attendee may be −0.5 hours if the meeting is scheduled at the first alternative meeting time. Based on the total focus times for the first and second attendees, the score for the first alternative meeting time is +2.5 hours (3−0.5=+2.5). If the meeting is scheduled at the second alternative meeting time, the total focus time for the first attendee may be +0.5 hours and the total focus time for the second attendee may be +1.5 hours. Based on the total focus times for the first and second attendees, the score for the second alternative meeting time is +2.0 hours (0.5+1.5=+2.0).

In some aspects, the focus time of each attendee can be weighted based on the attendee's role in the business or organization. For example, the focus time of a team manager can be weighted higher than the focus time of a member of the team, or the focus time of the CEO of a company may be weighted higher than the focus time of a vice-president in the company. Any suitable weighting factor can be used. In one non-limiting example, a weight can be computed by multiplying the focus time of an attendee by a ranking value associated with the title or role of the attendee. Alternatively, a weight can be computed by multiplying the change in the focus time of the attendee by a ranking value associated with the title or role of the attendee. The ranking values can be predefined by an enterprise or by a person or persons within the enterprise.

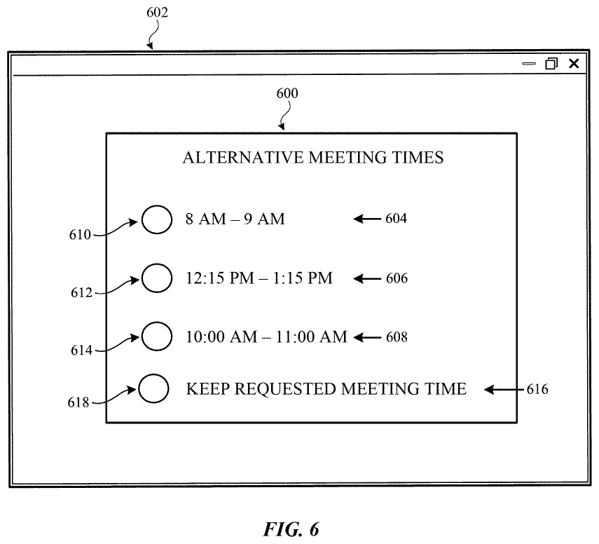

Next, as shown in block 214, one or more alternative meeting times are selected based on the computed score(s). For example, the top N alternative meeting times having the highest scores may be selected, where N is a number equal to or greater than 0. The selected alternative meeting time(s) are transmitted to a computing device for presentation to at least one attendee or user (block 216). For example, the one or more alternative meeting times can be presented to the meeting organizer and/or a team leader or manager. In one aspect, the alternative meeting time(s) can be presented in descending order of improved focus times. When no alternative meeting times are selected, a message can be sent to the attendee/user that informs the user of the lack of alternative meeting times. An example technique for proposing the alternative meeting time(s) is described in more detail in conjunction with FIG. 6.

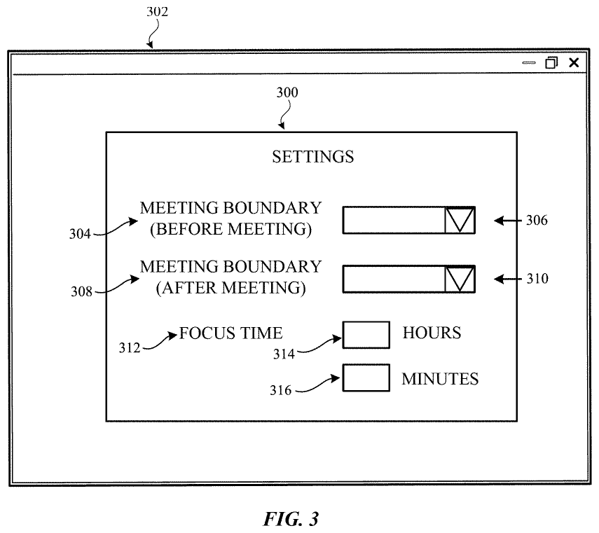

FIG. 3 illustrates an example preferences user interface for setting one or more meeting boundaries and an amount of focus time. The settings panel 300 is provided in a user interface 302, such as the user interface for an electronic calendar application. The settings panel 300 can be presented to each individual user of the electronic calendar application to enable the users to set the times for the meeting boundaries and the amount of focus time to their personal preferences. Alternatively, the settings panel 300 may be presented to an administrator or IT manager of an enterprise. The times for the meeting boundaries and the amount of focus time set by the administrator or IT manager can apply to all users (e.g., all employees) of the electronic calendar program.

A first setting for the meeting boundary before a meeting 304 can be set using the first user interface selection control 306. A second setting for the meeting boundary after a meeting 308 can be set using the second user interface selection control 310. The amount of times selected for the meeting boundaries can be the same or the time of the first meeting boundary setting can differ from the time of the second meeting boundary setting. Additionally, the amount of times can be entered as one or more hours and/or zero to fifty-nine minutes. Although the first and the second user interface selection controls 306, 310 are shown as drop boxes, any suitable user interface selection control can be used. For example, one or both user interface selection controls 306, 310 may be a dialog box, checkboxes, radio buttons, or switches.

A setting for the amount of focus time 312 can be set using the third user interface selection control 314 and/or the fourth user interface selection control 316. As shown, the amount of time can be entered as one or more hours and/or zero to fifty-nine minutes. Although the third and the fourth user interface selection controls 314, 316 are shown as dialog boxes, any suitable user interface selection control can be used. For example, one or both user interface selection controls 314, 316 may be a drop down menu, checkboxes, radio buttons, or switches.

FIG. 4A illustrates an example day in an electronic calendar prior to optimizing the electronic calendar. The focus time is defined as two or more hours in the illustrated embodiment. As shown in FIG. 4A, an existing first meeting 400 is scheduled from 9 am to 10 am, an existing second meeting 402 is scheduled from 11 am to 12 pm, and a request has been received to schedule a third meeting 404 from 1 pm to 2 pm (a one hour meeting). Assuming a work day for the attendee associated with the electronic calendar is 8 am to 5 pm, and assuming the requested meeting is actually scheduled from 1 pm to 2 pm, the total focus time for the user is three hours (2 pm to 5 pm). Since in this example the focus time period is defined as two or more hours, the time periods from 8 am to 9 am and 10 am to 11 am are not included in the total focus time calculation.

Assuming the meeting boundaries for this attendee is two hours, the meeting boundaries for the existing first meeting 400 are 8 am to 9 am (work day begins at 8 am) and 10 am to 12 pm. Within these meeting boundaries, the attendee has open time periods of 8 am to 9 am and 10 am to 11 am. The meeting boundaries for the existing second meeting 402 are 9 am to 11 am and 12 pm to 2 pm. Within these meeting boundaries, the attendee has open time periods of 10 am to 11 am and 12 pm to 2 pm. An optimizer program (e.g., optimizer program 116 in FIG. 1) can generate a notification panel that proposes one or more of these open time periods as an alternative meeting time. An example notification panel is described in more detail in conjunction with FIG. 6.

FIG. 4B depicts an example day in the electronic calendar shown in FIG. 4A after the calendar is optimized. In the illustrated embodiment, the alternative meeting time 406 of 12:15 pm to 1:15 pm has been accepted by a user (e.g., a team manager) or at least one attendee (e.g., the meeting organizer or each attendee). With the meeting scheduled at this alternative time, the total focus time for this attendee is three hours and forty-five minutes (1:15 pm to 5 pm). By optimizing the attendee's calendar, the amount of focus time has increased from three hours to three hours and forty-five minutes (or a positive difference of forty-five minutes). In one aspect, optimizing the electronic calendars of all attendees to the meeting can result in a significant increase in the total focus time for the attendees.

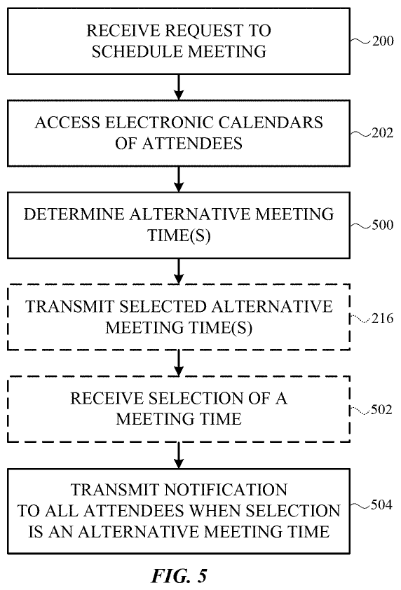

FIG. 5 is a flowchart of an example method of optimizing a new meeting in accordance with some embodiments. Initially, as shown in block 200, a request is received to schedule a meeting. The new meeting can be a recurring meeting or a one-time meeting. The electronic calendars of the attendees are then accessed and, based on the duration of the meeting, the date of the meeting, the meeting boundaries of the existing meetings, focus times, and the scores computed for each alternative meeting time, one or more alternative meeting times is determined (blocks 202, 500). In one embodiment, the operations of block 500 are similar to the operations in blocks 204, 206, 208, 210, 212, 214 of FIG. 2.

Next, as shown in block 216, one or more alternative meeting times are transmitted to at least one computing device for presentation to at least one attendee or user. For example, the alternative meeting time(s) can be sent to a computing device associated with the meeting organizer. A selection of a meeting time is received at block 502. The selection can be a selection of an alternative meeting time (see e.g., 610, 612, 614 in FIG. 6) or a selection to maintain the meeting time at the originally proposed meeting time (see e.g., 618 in FIG. 6). A notification (e.g., a meeting invitation) is sent to the attendees of the meeting when the selection is an alternate meeting time (block 504). For example, a calendar invitation can be sent to the attendees for the alternative meeting time.

Blocks 216 and 502 are optional and can be omitted in other embodiments. For example, a system or optimizer can automatically select (without user intervention) a meeting time based on at least one objective. For example, a meeting time that maximizes the improvement in the total focus time of the attendees (e.g., the sum of the individual attendee focus times) can be selected. Additionally or alternatively, a meeting time that provides greater improvement in the focus times of higher-level attendees (e.g., managers instead of team members) may be selected. In some instances, a meeting time that provides greater improvement in the focus times of attendees of a particular role or job (e.g., engineering instead of marketing) can be selected. The meeting time can be the originally requested meeting time or an alternative meeting time.

FIG. 6 depicts an example notification panel for presenting one or more alternative meeting times in accordance with some embodiments. In some aspects, the notification panel can be used to present the possible meeting time(s) at block 210 in FIGS. 2 and 5. The notification panel 600 is provided in a user interface 602, such as the user interface for the electronic calendar application. Three alternative meeting times 604, 606, 608 are displayed, along with radio buttons 610, 612, 614, respectively, that enable a user (e.g., a team manager) or an attendee (e.g., the meeting organizer) to select one of the alternative meeting times. In some instances, the order of the alternative meeting times is based on the scores computed for the possible meetings (see block 208 in FIG. 2).

The notification panel 600 also includes a selection 616 and radio button 618 that maintains the meeting at the original requested time (e.g., rejects the alternative meeting times). Although radio buttons are shown in FIG. 6, other embodiments are not limited to this configuration. Other user interface selection controls can be used, such as, for example, a drop-down menu, checkboxes, and switches. In some instances, the system can be configured to receive an audio response (e.g., a verbal input from the user) or text response that selects one of the options.

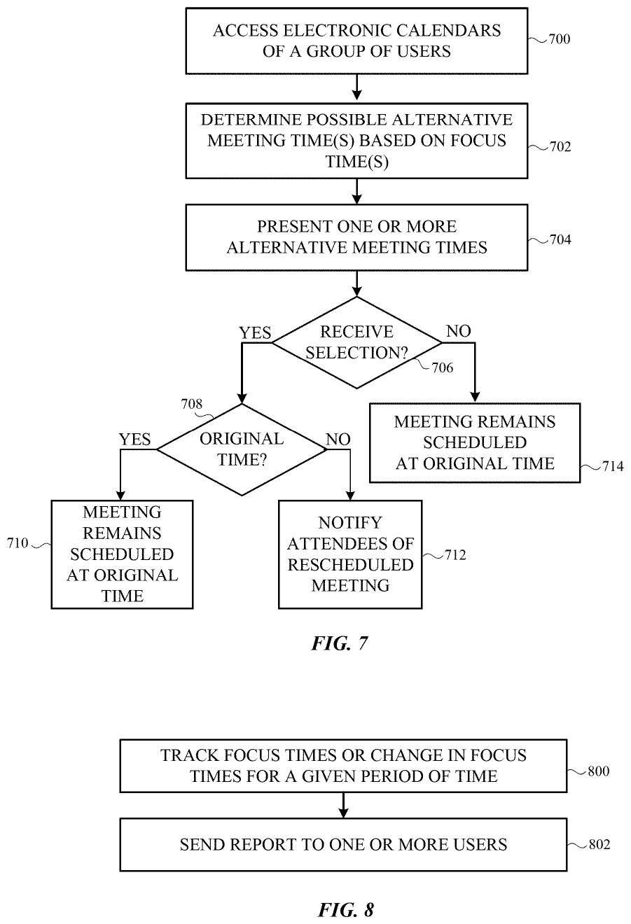

FIG. 7 is a flowchart of an example method of optimizing existing meetings previously scheduled in electronic calendars in accordance with some embodiments. The process can be performed for a group of users, such as all employees at an enterprise or a subset of the employees at an enterprise (e.g., a division of employees or the employees associated with a particular product or task). FIG. 7 is described in conjunction with one existing meeting, but other embodiments can implement the method for all existing meetings on the electronic calendars.

Initially, as shown in block 700, the electronic calendars associated with the attendees of the existing meeting are accessed. One or more alternative meeting times are determined based on focus time (block 702). The operations performed at block 702 can be similar to the operations shown in blocks 204, 206, 208, 210, 212, 214 of FIG. 2.

Next, as shown in block 704, one or more alternative meeting times are presented to at least one user or attendee associated with the meeting. The alternative meeting time(s) can be presented to at least one user/attendee based on the computed scores for the alternative time periods. The alternative meeting time(s) can be presented as shown in FIG. 6, or some other technique can be used. For example, an electronic communication, such as an electronic mail message or an instant message, may be sent to one or more users/attendees.

A determination is made at block 706 as to whether a selection is received. In some embodiments, the user can be give a period of time to submit his or her selection. For example, the user may be given eight or twenty-four hours to respond to the notification panel and provide a selection. When a selection is received, the process passes to block 708 where a determination is made as to whether the originally scheduled meeting time is selected. If so, the method continues at block 710 where no action is taken and the meeting remains scheduled on the electronic calendars at the original meeting time.

When the selection is not the original meeting time and an alternative meeting time is selected, the process passes to block 712 where the attendees of the meeting receive a notification of the new meeting time (e.g., the rescheduling of the meeting). In one aspect, the notification can be a revised calendar invite with the new meeting time. Alternatively, the electronic calendars of the attendees can automatically reschedule the meeting. In some instances, the attendees are notified of the automatic rescheduling.

When a selection is not received at block 706 within the given period of time, the method continues at block 714 where the meeting remains scheduled on the calendar at the original meeting time. For example, a user can ignore the notification or forget to respond within the given time period. In such situations, the meeting time on the attendee's electronic calendars is not changed.

The process of FIG. 7 can be performed periodically or at select times for all electronic calendars in an enterprise, or for a subset of the electronic calendars in the enterprise. Additionally, although not described in conjunction with block 502 in FIG. 5, a user can be given a period of time to submit his or her selection. For example, the user may be given twenty-four hours to respond to the notification panel and provide a selection.

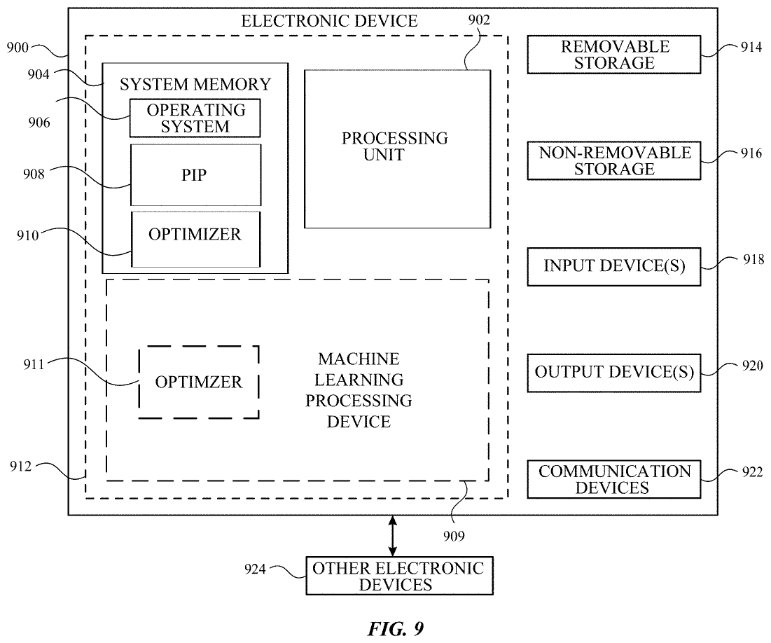

FIG. 8 is a flowchart of a method of monitoring and providing reports regarding calendar optimization in accordance with some embodiments. The focus times or the changes in the focus times for a set of one or more users is tracked for a given time period. For example, the focus times or the changes in the focus times can be monitored and recorded for a month, three months, six months, or a year. The data relating to the focus time can be stored in a memory, such as in a database (e.g., database 118 in FIG. 1).

Next, as shown in block 802, a report can be generated regarding the focus time(s) or changes in focus time(s) over the given time period and sent to one or more users. For example, a report can be sent to an attendee, a manager, a CEO, and/or a COO of an enterprise.

In one embodiment, an optimizer program (e.g., optimizer program 116 in FIG. 1) can perform the operations shown in FIGS. 2-7. The optimizer program can be a stand-alone program or the optimizer program may be incorporated into a PIP or calendar program. In some situations, the optimizer program can be implemented with artificial intelligence or machine learning techniques.

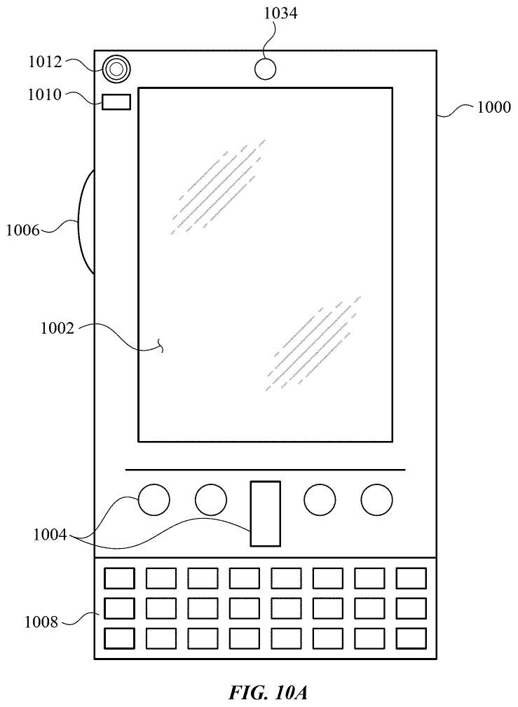

FIGS. 9-11 and the associated descriptions provide a discussion of a variety of operating environments in which aspects of the disclosure may be practiced. However, the devices and systems illustrated and discussed with respect to FIGS. 9-11 are for purposes of example and illustration and are not limiting of a vast number of electronic device configurations that may be utilized for practicing aspects of the disclosure, as described herein.

FIG. 9 is a block diagram illustrating physical components (e.g., hardware) of an electronic device 900 with which aspects of the disclosure may be practiced. In a basic configuration, the electronic device 900 may include at least one processing unit 902 and a system memory 904. Any suitable processing unit 902 can be used. For example, the processing unit 902 may be a microprocessor, an application specific integrated circuit, a field programmable gate array, or combinations thereof.

Depending on the configuration and type of the electronic device 900, the system memory 904 may comprise, but is not limited to, volatile storage (e.g., random access memory), non-volatile storage (e.g., read-only memory), flash memory, or any combination of such memories. The system memory 904 may include a number of program modules and data files, such as an operating system 906, a PIP application 908, and an optimizer application 910. While executing on the processing unit 902, the optimizer application 910 may perform and/or cause to be performed processes including, but not limited to, the aspects as described herein.

In some embodiments, the electronic device 900 can include a machine learning processing device 909 that executes the optimizer program 911. The machine learning processing device 909 can be any suitable type of processing device. In a non-limiting example, the machine learning processing device 909 may be a central processing unit, a microprocessor, a field programmable gate array, an application specific integrated circuit, a graphic processing unit, or combinations thereof.

While executing on the machine learning processing device 909, the optimizer application 910 may perform and/or cause to be performed processes including, but not limited to, the aspects as described herein. The machine learning processing device 909 and the optimizer program 910 can be any suitable type of machine learning or artificial intelligence that learns over time and improves the calendar optimization process. For example, the optimizer application 910, executing on the machine learning processing device 909, can learn an attendee's preferred times for meetings, identify which attendees are more flexible for rescheduled meetings, learn the order in which meeting should be optimized, and the like. Using the learned aspects of optimizing calendars, over time the optimizer application 910 and machine learning processing device 909 may become more efficient and effective in optimizing calendars.

The operating system 906, for example, may be suitable for controlling the operation of the electronic device 900. Furthermore, embodiments of the disclosure may be practiced in conjunction with a graphics library, other operating systems, or any other application program and is not limited to any particular application or system. This basic configuration is illustrated in FIG. 9 by those components within a dashed line 912.

The electronic device 900 may have additional features or functionality. For example, the electronic device 900 may also include additional data storage devices (removable and/or non-removable) such as, for example, magnetic disks, optical disks, or tape. Such additional storage is illustrated in FIG. 9 by a removable storage device 914 and a non-removable storage device 916.

The electronic device 900 may also have one or more input device(s) 918 such as a keyboard, a trackpad, a mouse, a pen, a sound or voice input device, a touch, force and/or swipe input device, etc. The output device(s) 920 such as a display, speakers, a printer, etc. may also be included. The aforementioned devices are examples and others may be used. The electronic device 900 may include one or more communication devices 922 allowing communications with other electronic devices 924. Examples of suitable communication devices 922 include, but are not limited to, radio frequency (RF) transmitter, receiver, and/or transceiver circuitry; universal serial bus (USB), parallel, and/or serial ports.

The term computer-readable media as used herein may include computer storage media. Computer storage media may include volatile and nonvolatile, removable and non-removable media implemented in any method or technology for storage of information, such as computer readable instructions, data structures, or program modules.

The system memory 904, the removable storage device 914, and the non-removable storage device 916 are all computer storage media examples (e.g., memory storage or storage device). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the electronic device 900. Any such computer storage media may be part of the electronic device 900. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 9 may be integrated onto a single integrated circuit. Such an SOC device may include one or more processing units, graphics units, communications units, system virtualization units and various application functionality all of which are integrated (or “burned”) onto the chip substrate as a single integrated circuit.

When operating via an SOC, the functionality, described herein, with respect to the capability of client to switch protocols may be operated via application-specific logic integrated with other components of the electronic device 900 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

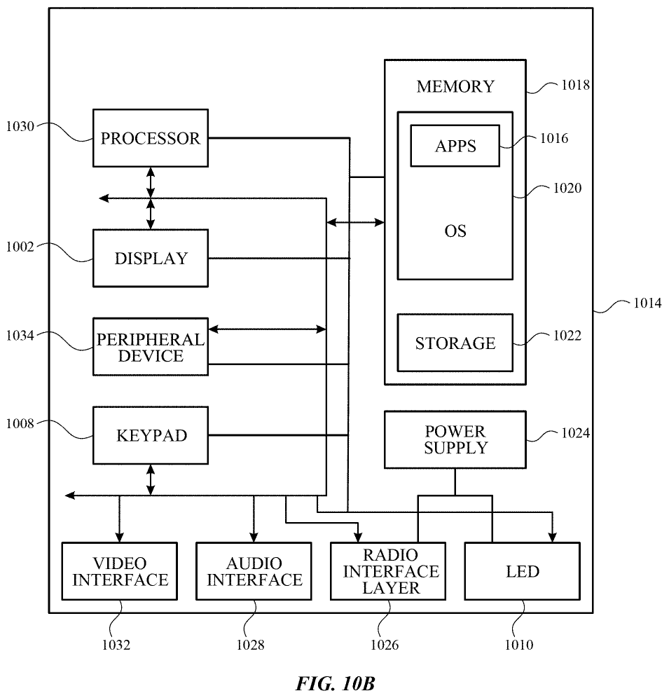

FIGS. 10A and 10B illustrate a mobile electronic device 1000, for example, a mobile telephone, a smart phone, wearable computer (such as a smart watch), a tablet computer, a laptop computer, and the like, with which embodiments of the disclosure may be practiced. With reference to FIG. 10A, one aspect of a mobile electronic device 1000 for implementing the aspects described herein is illustrated.

In a basic configuration, the mobile electronic device 1000 is a handheld computer having both input elements and output elements. The mobile electronic device 1000 typically includes a display 1002 and one or more input buttons 1004 that allow the user to enter information into the mobile electronic device 1000. The display 1002 of the mobile electronic device 1000 may also function as an input device (e.g., a display that accepts touch and/or force input).

If included, an optional side input element 1006 allows further user input. The side input element 1006 may be a rotary switch, a button, or any other type of manual input element. In alternative aspects, mobile electronic device 1000 may incorporate more or less input elements. For example, the display 1002 may not be a touch screen in some embodiments. In yet another alternative embodiment, the mobile electronic device 1000 is a portable phone system, such as a cellular phone. The mobile electronic device 1000 may also include an optional keypad 1008. Optional keypad 1008 may be a physical keypad or a “soft” keypad generated on the touch screen display.

In various embodiments, the output elements include the display 1002 for showing a graphical user interface (GUI) of an calendaring or PIP program, a visual indicator 1010 (e.g., a light emitting diode), and/or an audio transducer 1012 (e.g., a speaker). In some aspects, the mobile electronic device 1000 incorporates a vibration transducer for providing the user with tactile feedback. In yet another aspect, the mobile electronic device 1000 incorporates input and/or output ports, such as an audio input (e.g., a microphone jack), an audio output (e.g., a headphone jack), and a video output (e.g., a HDMI port) for sending signals to or receiving signals from an external device.

FIG. 10B is a block diagram illustrating the architecture of one aspect of a mobile electronic device 1000. That is, the mobile electronic device 1000 can incorporate a system (e.g., an architecture) 1014 to implement some aspects. In one embodiment, the system 1014 is implemented as a “smart phone” capable of running one or more applications (e.g., browser, e-mail, calendaring, contact managers, messaging clients, games, media clients/players, diagramming, and sharing applications and so on). In some aspects, the system 1014 is integrated as an electronic device, such as an integrated personal digital assistant (PDA) and wireless phone.

One or more application programs 1016 may be loaded into the memory 1018 and run on or in association with the operating system 1020. Examples of the application programs include phone dialer programs, e-mail programs, PIP programs, optimizer programs, word processing programs, spreadsheet programs, Internet browser programs, messaging programs, and so forth.

The system 1014 also includes a non-volatile storage area 1022 within the memory 1018. The non-volatile storage area 1022 may be used to store persistent information that should not be lost when the system 1014 is powered down.

The application programs 1016 may use and store information in the non-volatile storage area 1022, such as email, attachments or other messages used by an email application, and the like. A synchronization application (not shown) also resides on the system 1014 and is programmed to interact with a corresponding synchronization application resident on a host computer to keep the information stored in the non-volatile storage area 1022 synchronized with corresponding information stored at the host computer.

The system 1014 has a power supply 1024, which may be implemented as one or more batteries. The power supply 1024 may further include an external power source, such as an AC adapter or a powered docking cradle that supplements or recharges the batteries.

The system 1014 may also include a radio interface layer 1026 that performs the function of transmitting and receiving radio frequency communications. The radio interface layer 1026 facilitates wireless connectivity between the system 1014 and the “outside world,” via a communications carrier or service provider. Transmissions to and from the radio interface layer 1026 are conducted under control of the operating system 1020. In other words, communications received by the radio interface layer 1026 may be disseminated to the application programs 1016 via the operating system 1020, and vice versa.

The visual indicator 1010 may be used to provide visual notifications, and/or an audio interface 1028 may be used for producing audible notifications via an audio transducer (e.g., audio transducer 1012 illustrated in FIG. 10A). In the illustrated embodiment, the visual indicator 1010 is a light emitting diode (LED) and the audio transducer 1012 may be a speaker. These devices may be directly coupled to the power supply 1024 so that when activated, they remain on for a duration dictated by the notification mechanism even though the processor 1030 and other components might shut down for conserving battery power. The LED may be programmed to remain on indefinitely until the user takes action to indicate the powered-on status of the device.

The audio interface 1028 is used to provide audible signals to and receive audible signals from the user (e.g., voice input such as described above). For example, in addition to being coupled to the audio transducer 1012, the audio interface 1028 may also be coupled to a microphone to receive audible input, such as to facilitate a telephone conversation. In accordance with embodiments of the present disclosure, the microphone may also serve as an audio sensor to facilitate control of notifications, as will be described below.

The system 1014 may further include a video interface 1032 that enables an operation of peripheral device 1034 (e.g., on-board camera) to record still images, video stream, and the like.

A mobile electronic device 1000 implementing the system 1014 may have additional features or functionality. For example, the mobile electronic device 1000 may also include additional data storage devices (removable and/or non-removable) such as, magnetic disks, optical disks, or tape. Such additional storage is illustrated in FIG. 10B by the non-volatile storage area 1022.

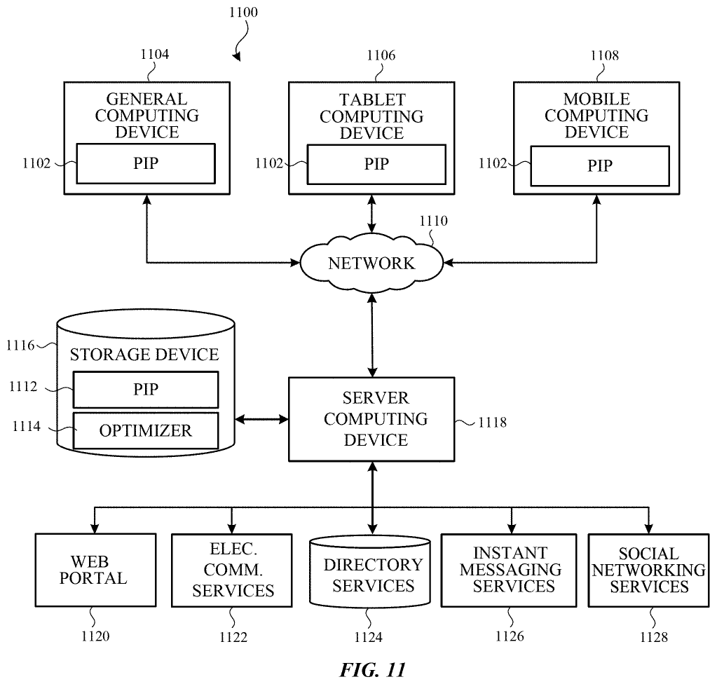

Data/information generated or captured by the mobile electronic device 1000 and stored via the system 1014 may be stored locally on the mobile electronic device 1000, as described above, or the data may be stored on any number of storage media that may be accessed by the device via the radio interface layer 1026 or via a wired connection between the mobile electronic device 1000 and a separate electronic device associated with the mobile electronic device 1000, for example, a server-computing device in a distributed computing network, such as the Internet (e.g., server computing device 1118 in FIG. 11). As should be appreciated such data/information may be accessed via the mobile electronic device 1000 via the radio interface layer 1026 or via a distributed computing network. Similarly, such data/information may be readily transferred between electronic devices for storage and use according to well-known data/information transfer and storage means, including electronic mail and collaborative data/information sharing systems.

As should be appreciated, FIG. 10A and FIG. 10B are described for purposes of illustrating the present methods and systems and is not intended to limit the disclosure to a particular sequence of steps or a particular combination of hardware or software components.

FIG. 11 is a block diagram illustrating a distributed system in which aspects of the disclosure may be practiced. The system includes a PIP program 1102 in a general computing device 1104 (e.g., a desktop computer), a tablet computing device 1106, and/or a mobile computing device 1108. The general computing device 1104, the tablet computing device 1106, and the mobile computing device 1108 can each include the components, or be connected to the components, that are shown associated with the electronic device 900 in FIG. 9 or the mobile electronic device 1000 in FIGS. 10A-10B.

The general computing device 1104, the tablet computing device 1106, and the mobile computing device 1108 are each configured to access one or more networks (represented by network 1110) to interact with a PIP 1112 and/or an optimizer program 1114 stored in one or more storage devices (represented by storage device 1116) and executed on one or more server computing devices (represented by server computing device 1118). In some aspects, the server computing device 1118 can access and/or receive various types of services, communications, documents and information transmitted from other sources, such as a web portal 1120, an electronic communications services 1122, directory services 1124, instant messaging and/or text services 1126, and/or social networking services 1128. In some instances, these sources may provide robust reporting, analytics, data compilation and/or storage service, etc., whereas other services may provide search engines or other access to data and information, images, graphics, videos, document processing and the like.

As should be appreciated, FIG. 11 is described for purposes of illustrating the present methods and systems and is not intended to limit the disclosure to a particular sequence of steps or a particular combination of hardware or software components.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternative aspects falling within the spirit of the broader aspects of the general inventive concept embodied in this application that do not depart from the broader scope of the claimed disclosure.

1. A method, comprising:
in response to receiving, over a network, a request to schedule a meeting, analyzing, by a processing device, computer-generated calendar data associated with the electronic calendar of each attendee to the meeting, wherein the request includes a date for the meeting, a start time for the meeting, an end time for the meeting, and the attendees;
for each attendee, determining one or more open time periods within a meeting boundary associated with any existing meetings on the date, the meeting boundary comprising a period of time immediately before or immediately after an existing meeting, wherein at least one attendee has an existing meeting on the date;
for each open time period, determining, by the processing device, an amount of focus time for each attendee;
computing, by the processing device, a score for each open time period based on the amounts of focus times determined for that open time period;
based on each score, selecting, by a processing device, one or more alternative meeting times for the meeting; and
transmitting, over the network to a computing device associated with at least one attendee, a notification indicating the one or more alternative meeting times and a user interface selection control for each alternative meeting time.

2. The method of claim 1, further comprising receiving, over the network by the processing device, a selection of the user interface selection control associated with a particular alternative meeting time.

3. The method of claim 2, further comprising causing, by the processing device, a calendar invitation to be transmitted to the attendees for scheduling the meeting at the particular alternative meeting time.

4. The method of claim 1, wherein the notification panel includes a user interface selection lcontrol associated with the meeting time in the request.

5. The method of claim 4, further comprising receiving, over the network by the processing device, a selection of the user interface selection control associated with the original meeting time.

6. The method of claim 5, wherein the meeting on the electronic calendars remains scheduled at the meeting time in the request.

7. The method of claim 1, further comprising:
recording changes in the amounts of focus times over a given period of time;
sending a report on the changes in the amounts of focus times over the given period of time to at least one user.

8. The method of claim 1, further comprising prior to determining the amount of focus time for each attendee, determining the meeting boundary associated with each attendee.

9. The method of claim 8, wherein the meeting boundary is a same predetermined period of time for the plurality of attendees.

10. A system, comprising:
a processing device;
a memory storing instructions, that when executed by the processing device, cause operations to be performed, the operations comprising:
receiving, over a network, a request to schedule a meeting on electronic calendars associated with a plurality of attendees, the request including a date for the meeting, a meeting start time, a meeting end time, and the plurality of attendees;
in response to receiving the request, analyzing computer-generated calendar data associated with the electronic calendars of each attendee;
for each attendee, determining one or more open time periods within a meeting boundary associated with any existing meetings on the date, the meeting boundary comprising a period of time immediately before or immediately after an existing meeting, wherein at least one attendee has an existing meeting on the date;
for each open time period, determining an amount of focus time for each attendee;
computing a score for each open time period based on the amounts of focus times determined for that open time period;
based on each score, selecting one or more alternative meeting times for the meeting; and
transmitting, over the network, a notification that includes the one or more alternative meeting times and a user interface selection control for each alternative meeting time to a computing device associated with at least one attendee.

11. The system of claim 10, wherein the memory stores further instructions for receiving, over the network, a selection of the user interface selection control associated with a particular alternative meeting time.

12. The system of claim 11, wherein the memory stores further instructions for causing a calendar invitation to be transmitted to the attendees for scheduling the meeting at the particular alternative meeting time.

13. The system of claim 10, wherein the notification includes a user interface selection control associated with the meeting time in the request.

14. The system of claim 13, wherein the memory stores further instructions for receiving, over the network, a selection of the user interface selection control associated with the meeting time in the request.

15. The system of claim 14, wherein the meeting on the electronic calendars is scheduled at the meeting time in the request.

16. The system of claim 10, wherein the memory stores further instructions for:
recording changes in the amounts of focus times over a given period of time;
sending a report on the changes in the amounts of focus times over the given period of time to at least one user.

17. The system of claim 14, wherein the at least one user comprises an attendee or a manager in an enterprise.

18. A method, comprising:
analyzing, by a processing device, computer-generated calendar data associated with a plurality of electronic calendars;
for a first existing meeting scheduled on the plurality of electronic calendars, determining, by the processing device, one or more open time periods within a meeting boundary associated with a second existing meeting scheduled on a day of the first meeting on one of the plurality of electronic calendars, the meeting boundary comprising a period of time immediately before or immediately after the second existing meeting;
for each open time period, determining, by the processing device, an amount of focus time for each attendee of the first existing meeting;
computing, by the processing device, a score for each open time period based on the amounts of focus times determined for that open time period;
based on each score, selecting, by a processing device, one or more alternative meeting times for the first existing meeting;
transmitting, by the processing device over the network to a computing device associated with at least one attendee of the first existing meeting, a notification comprising:
the one or more alternative meeting times;
a user interface selection control for each alternative meeting time;
a meeting time of the first existing meeting; and
a user interface selection for the meeting time of the first existing meeting;
determining, by the processing device, if a selection is received within a given period of time in response to the notification;
when a selection is received within the given time period, and the selection is one of the one or more alternative meeting times, causing, by a processing device, a notification to be transmitted to each attendee of the first existing meeting regarding the alternative meeting time; and
when a selection is received within the given time period, and the selection is the meeting time of the first existing meeting, maintaining the first existing meeting on the plurality of electronic calendars at the meeting time of the first existing meeting.

19. The method of claim 18, further comprising when the selection is not received within the given time period, maintaining the first existing meeting on the plurality of electronic calendars at the meeting time of the first existing meeting.

20. The method of claim 18, wherein the plurality of electronic calendars are associated with an enterprise and the method is performed at select times.
